(19) United States
(12) Patent Application Publication
(10) Pub. No.: US 2026/0080565 A1
(43) Pub. Date: Mar. 19, 2026

(54) ARTICULATED STRUCTURE POSE ESTIMATION

(71) Applicant: Intel Corporation, Santa Clara, CA (US)

(72) Inventors: Javier Felip Leon, Hillsboro, OR (US); David Israel Gonzalez Aguirre, Hillsboro, OR (US); Edgar Macias Garcia, Zapopan (MX); Julio Zamora Esquivel, West Sacramento, CA (US)

(21) Appl. No.: 19/341,417

(22) Filed: Sep. 26, 2025

(51) Int. Cl. G06T 7/73; G06V 10/77; G06V 40/10

(52) U.S. Cl. CPC G06T 7/73; G06V 10/77; G06V 40/11; G06T 2207/20076; G06T 2207/20081; G06T 2207/30196

(57) ABSTRACT

An articulated structure pose estimation system, including: a plurality of synergy space encoders, each configured to generate a respective probability distribution in a synergy space having fewer dimensions than a full joint space, the full joint space corresponding to a multi-degree-of-freedom model of an articulated structure, wherein different ones of the synergy space encoders are configured to encode different contextual or observational information related to articulated structure pose estimation; a synergy heatmap solver configured to: combine the respective probability distributions from the plurality of synergy space encoders to generate a combined probability distribution in the synergy space; and perform probabilistic inference on the combined probability distribution to determine an inferred synergy point; and a synergy decoder configured to decode the inferred synergy point into a pose representation of the articulated structure in the full joint space.

### TECHNICAL FIELD

The present disclosure relates to hand pose estimation systems, and more particularly to a system for estimating hand joint configurations from input data using hand synergies, contextual information, and scene perception to provide robust performance during occlusions caused by object manipulation.

### BACKGROUND

Extended Reality (XR) applications and robot programming by demonstration increasingly rely on accurate hand pose estimation to enable natural human-computer interaction and skill transfer. Hand pose estimation involves inferring the hand joint configuration and the wrist's three-dimensional position and orientation from visual input, such as camera images. This capability is crucial for tasks ranging from virtual object manipulation in XR to teaching robots through human demonstration.

Human hands are highly articulated, with twenty-two degrees of freedom (DoF), which makes pose estimation computationally complex. Traditional approaches detect hand keypoints in images and reconstruct poses through inverse kinematics or physics-based models. While effective when the hand is fully visible, these methods perform poorly during object interaction, where occlusions are most frequent and accuracy is most critical. For example, when grasping or manipulating objects, fingers and palm regions are often hidden, leading to incomplete or infeasible pose estimates.

Working directly in the 22-DoF space further compounds the problem, as not all configurations are physically realizable, and models often fail to integrate task or scene context.

Research shows, however, that human hand movements can be effectively described in a lower-dimensional synergy space. A small number of principal components, typically nine, capture the most common and functional joint motions. This representation reduces complexity, avoids infeasible poses, and better reflects the natural coupling of hand joints. Yet existing solutions underutilize this structure and lack integration of contextual task and scene information.

There remains a need for robust hand pose estimation systems that can cope with occlusions and generate feasible, context-aware configurations by leveraging the synergy space.

### BRIEF DESCRIPTION OF THE FIGURES

FIG. 1 illustrates a hand pose estimation system, according to aspects of the present disclosure.

FIG. 2 depicts encoder results combined, according to aspects of the disclosure.

FIG. 3 illustrates a computing device 300, according to aspects of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes a hand pose estimation system designed to address the challenges of inferring human hand configurations from input data, such as camera images, particularly under conditions of occlusion during object manipulation.

The hand pose estimation system described herein employs multiple probabilistic encoders that generate probability distributions within the synergy space. Each encoder may capture different aspects of the hand pose estimation problem, including environmental constraints, observed hand features, user-specific behaviors, and temporal dynamics. These encoders may operate in parallel to produce complementary probability maps that represent different sources of information about the likely hand configuration.

The probabilistic approach allows the system to handle uncertainty and partial information, which may be particularly beneficial when hands are partially occluded during object manipulation tasks. Rather than attempting to directly estimate joint angles from incomplete visual information, the system may combine multiple sources of probabilistic evidence to infer the most likely hand configuration in the synergy space. This approach may provide robustness against occlusions while maintaining computational efficiency through the reduced-dimensional representation.

The synergy space representation may be learned from demonstration data or derived through statistical analysis of hand movement patterns. In some cases, the dimensionality may be further reduced to fewer dimensions for applications where computational efficiency takes precedence over pose fidelity. The flexibility in dimensional reduction allows the system to be adapted for different computational platforms and application requirements, from high-performance computing environments to resource-constrained mobile devices.

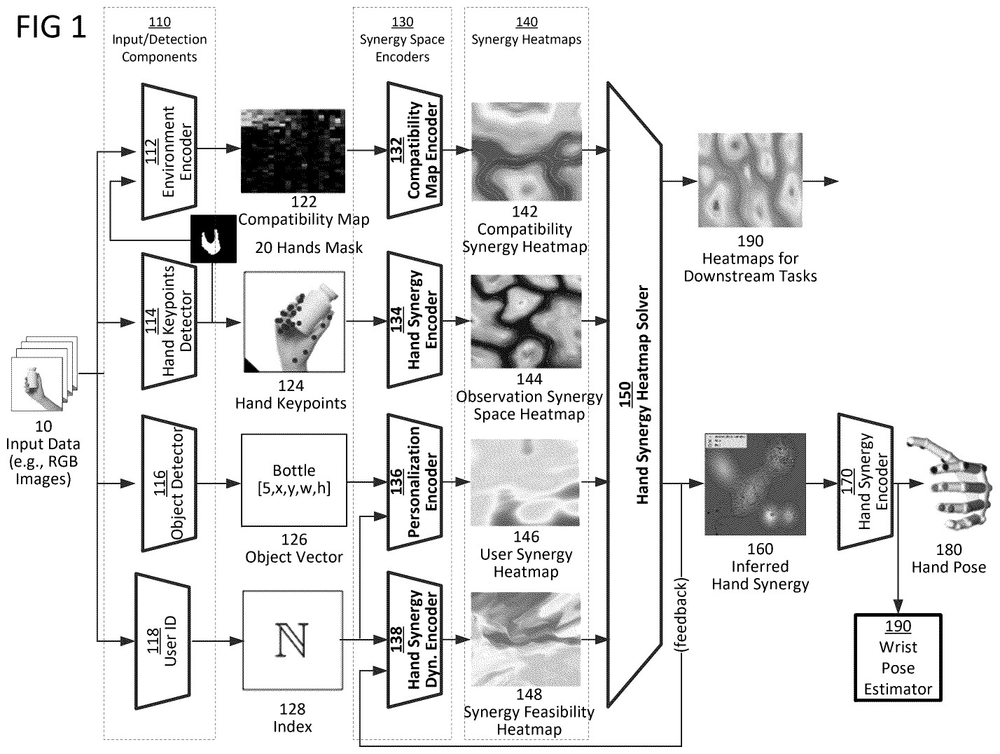

Referring to FIG. 1, a hand pose estimation system 100 receives input data 10 and processes the input data 10 through multiple parallel processing pathways to generate hand pose estimates. The input data 10 may comprise RGB images, depth sensor data, or other visual information captured from one or more cameras observing hand movements and interactions. The hand pose estimation system 100 may be configured to operate on various computational platforms, including CPU-based devices, vision processing units (VPUs), and smart-camera systems. In some cases, the hand pose estimation system 100 may utilize a multi-camera data capture system for generating high-quality training data and fine-tuning pre-trained models to specific tasks or environments.

The hand pose estimation system 100 includes input/detection components 110 that perform initial processing and feature extraction from the input data 10. The input/detection components 110 may operate in parallel to extract different types of information from the input data 10, enabling comprehensive analysis of the visual scene. Each component within the input/detection components 110 may be implemented using machine learning models, computer vision algorithms, or hybrid approaches that combine multiple processing techniques. The parallel processing architecture of the input/detection components 110 may enable real-time performance while maintaining accuracy across different types of input scenarios.

As further shown in FIG. 1, the input/detection components 110 comprise an environment encoder 112, a hand keypoints detector 114, an object detector 116, and a user identifier 118. The environment encoder 112 may analyze the visual scene to identify environmental features, spatial relationships, and contextual information that may influence hand pose configurations. The hand keypoints detector 114 may locate and track specific anatomical landmarks on detected hands, such as fingertips, joint locations, and palm centers. The object detector 116 may identify and classify objects present in the scene, particularly those that may be involved in hand-object interactions or may cause occlusions. The user identifier 118 may determine the identity of the person whose hand is being tracked, enabling personalized pose estimation based on individual hand characteristics and movement patterns.

The processing performed by the input/detection components 110 generates multiple output streams that capture different aspects of the input data 10. A compatibility map 122 may be generated by the environment encoder 112 and may represent spatial and contextual constraints that influence feasible hand configurations within the observed environment. Hand keypoints 124 may be produced by the hand keypoints detector 114 and may comprise coordinate locations of detected anatomical landmarks, along with associated confidence values for each detected point. An object vector 126 may be generated by the object detector 116 and may encode information about detected objects, including object classifications, spatial positions, orientations, and geometric properties. An index 128 may be produced by the user identifier 118 and may provide a unique identifier or classification for the detected user, enabling access to personalized models and parameters.

The hand pose estimation system 100 may be pre-trained using existing hand interaction datasets to establish baseline mappings between visual inputs and synergy space representations. In some cases, datasets may be utilized during pre-training to provide ground truth annotations for hand keypoints and joint configurations. The pre-training process may enable the input/detection components 110 to develop robust feature extraction capabilities across diverse hand poses and interaction scenarios. The multi-camera training setup may reduce occlusion problems during data collection by providing multiple viewpoints of hand movements, enabling the generation of comprehensive training datasets that include heavily occluded scenarios.

With continued reference to FIG. 1, the hand pose estimation system 100 includes synergy space encoders 130 that transform the outputs from the input/detection components 110 into probability distributions within a reduced-dimensional synergy space. The synergy space encoders 130 may operate in parallel to process different types of input information and generate complementary probability representations that capture various aspects of hand pose constraints and observations. Each encoder within the synergy space encoders 130 may be implemented using machine learning models, statistical methods, or hybrid approaches that combine multiple processing techniques. The synergy space encoders 130 may be configured to operate within a synergy space that represents hand configurations using approximately 9 dimensions, though in some cases the dimensionality may be reduced to as few as 5 dimensions for applications where computational efficiency takes precedence over pose fidelity.

The synergy space encoders 130 comprise a compatibility map encoder 132, a hand synergy encoder 134, a personalization encoder 136, and a hand synergy dynamics encoder 138. The compatibility map encoder 132 may receive the compatibility map 122 from the environment encoder 112 and may transform environmental and contextual constraints into a probability distribution within the synergy space. The hand synergy encoder 134 may process detected hand features to generate synergy space representations based on observed hand configurations. The personalization encoder 136 may utilize user-specific information to generate probability distributions that reflect individual hand movement patterns and preferences. The hand synergy dynamics encoder 138 may incorporate temporal information and learned motion models to generate probability distributions that enforce realistic hand movement transitions and dynamics within the synergy space.

As further shown in FIG. 1, the synergy space encoders 130 generate synergy heatmaps 140 that represent probability distributions within the synergy space. The synergy heatmaps 140 may comprise visual or computational representations of probability density functions that indicate the likelihood of different hand configurations within the reduced-dimensional space. Each heatmap within the synergy heatmaps 140 may encode different types of constraints or observations, enabling the system to combine multiple sources of information during the inference process. The synergy heatmaps 140 may be represented as discrete probability grids, continuous probability density functions, or parametric distributions that can be efficiently processed by downstream components.

The compatibility map encoder 132 may generate a compatibility synergy heatmap 142 that represents environmental and contextual constraints on feasible hand poses within the synergy space. The compatibility map encoder 132 may process the compatibility map 122 to identify spatial relationships between hands, objects, and environmental features that influence possible hand configurations. In some cases, the compatibility map encoder 132 may mask detected hands using random pixel values or may segment static and dynamic objects to remove hand silhouettes, thereby focusing the encoding process on environmental constraints rather than direct hand observations. The compatibility map encoder 132 may alternatively utilize initial images captured before a hand presence in the scene and may label interactions that occurred in each scene by summarizing hand synergy trajectories or averaging trajectory data to generate contextual probability maps.

The hand synergy encoder 134 may process hand-related observations to generate an observation synergy heatmap 144 that represents the likelihood of different hand configurations based on detected features. The hand synergy encoder 134 may be implemented using Principal Component Analysis (PCA) with precomputed projection matrices for computational efficiency, enabling rapid transformation of hand observations into the synergy space. In some cases, the hand synergy encoder 134 may be implemented using neural networks to capture nonlinear dependencies between joints and may adapt to variations in hand movements over time. The hand synergy encoder 134 may incorporate hand segmentation models to preprocess images and may focus processing solely on detected hand regions, thereby reducing training complexity and preventing the extraction of irrelevant environmental information from input images.

The personalization encoder 136 may generate a user synergy heatmap 146 that reflects individual user characteristics and movement patterns within the synergy space. The personalization encoder 136 may operate as an online learning block that continuously adapts to individual users by collecting data points during interactions and may refine probability distributions based on observed user-specific behaviors. The personalization encoder 136 may receive the index 128 from the user identifier 118 and may access stored user profiles or may dynamically update user models based on ongoing interactions. The user synergy heatmap 146 may encode individual preferences for grasping specific objects, personal hand movement patterns, and user-specific constraints that influence hand pose configurations during different types of tasks.

The hand synergy dynamics encoder 138 may process temporal information and learned motion models to generate a synergy feasibility heatmap 148 that enforces realistic hand movement transitions within the synergy space. The hand synergy dynamics encoder 138 may utilize dynamical system identification techniques to model hand movement patterns and may incorporate probabilistic dynamics that account for uncertainty in human hand movements. The synergy feasibility heatmap 148 may constrain inference results to follow anatomically feasible movement trajectories and may prevent unrealistic transitions between hand configurations. The hand synergy dynamics encoder 138 may learn user-specific dynamics over time and may adapt motion models based on observed movement patterns, enabling personalized enforcement of temporal consistency in hand pose estimation results.

The hand synergy dynamics encoder 138 may be implemented using multiple approaches that capture temporal relationships and movement patterns within the synergy space. The implementation of the hand synergy dynamics encoder 138 may focus on learning realistic hand movement transitions and enforcing temporal consistency constraints that prevent anatomically infeasible pose sequences. The hand synergy dynamics encoder 138 may operate by analyzing historical hand movement data to identify patterns and relationships that govern how hands transition between different configurations during manipulation tasks. The temporal modeling capabilities of the hand synergy dynamics encoder 138 may enable the system to predict likely future hand states based on current and previous configurations, thereby improving robustness when visual observations are incomplete or occluded.

One implementation approach for the hand synergy dynamics encoder 138 may utilize dynamical system identification techniques to model hand movement patterns within the synergy space. The hand synergy dynamics encoder 138 may employ Sparse Identification of Nonlinear Dynamical systems (SINDy) techniques to discover governing equations that describe hand movement dynamics from observed trajectory data. The SINDy approach may enable the hand synergy dynamics encoder 138 to identify sparse representations of the underlying dynamical system by selecting relevant terms from a library of candidate functions, including polynomial terms, trigonometric functions, and other basis functions that may capture the nonlinear relationships between synergy space coordinates. The dynamical system identification process may incorporate probabilistic dynamics that account for uncertainty and variability in human hand movements, enabling the hand synergy dynamics encoder 138 to generate probability distributions rather than deterministic predictions.

The probabilistic dynamics modeling within the hand synergy dynamics encoder 138 may account for natural variations in human movement patterns and may provide uncertainty estimates that reflect the confidence in predicted hand configurations. The hand synergy dynamics encoder 138 may learn separate dynamical models for different types of manipulation tasks, enabling task-specific temporal constraints that reflect the characteristic movement patterns associated with particular activities. The probabilistic framework may allow the hand synergy dynamics encoder 138 to handle situations where multiple plausible hand trajectories exist, providing probability distributions that capture the range of feasible movement options. The dynamical system identification approach may enable the hand synergy dynamics encoder 138 to adapt to individual users by learning personalized movement dynamics that reflect unique hand movement characteristics and preferences.

An alternative implementation approach for the hand synergy dynamics encoder 138 may utilize clustering algorithms to identify discrete synergy modes and model transitions between these modes. The hand synergy dynamics encoder 138 may employ clustering algorithms such as Density-Based Spatial Clustering of Applications with Noise (DBSCAN) to identify regions of high density within the synergy space that correspond to commonly used hand configurations. The clustering approach may enable the hand synergy dynamics encoder 138 to discover natural groupings of hand poses that represent functionally similar grasping or manipulation configurations. The DBSCAN algorithm may be particularly suitable for synergy space analysis because the algorithm may handle clusters of varying shapes and densities while identifying outlier configurations that may represent transitional or uncommon hand poses.

With continued reference to FIG. 1, the clustering-based implementation of the hand synergy dynamics encoder 138 may generate transition models by analyzing observed transitions between identified synergy modes. The hand synergy dynamics encoder 138 may construct transition probability matrices that encode the likelihood of moving from one synergy mode to another based on observed hand movement sequences. The transition models may be generated by analyzing temporal sequences of hand configurations and identifying patterns in how hands move between different synergy modes during various manipulation tasks. The hand synergy dynamics encoder 138 may create an incidence matrix that represents the connectivity between different synergy modes, where unconnected nodes may have low transition probabilities to ensure that the system enforces realistic and feasible hand pose transitions.

The clustering-based approach may enable the hand synergy dynamics encoder 138 to provide interpretable representations of hand movement patterns by associating each synergy mode with characteristic hand configurations and functional roles. The hand synergy dynamics encoder 138 may learn mode-specific dwell times that represent how long hands typically remain in particular configurations before transitioning to other modes. The transition models may incorporate temporal dependencies that consider not only the current synergy mode but also the sequence of previous modes, enabling the hand synergy dynamics encoder 138 to capture higher-order movement patterns and contextual dependencies. The clustering approach may facilitate real-time processing by reducing the continuous synergy space to a discrete set of modes, enabling efficient computation of transition probabilities and temporal constraints during hand pose inference.

With continued reference to FIG. 1, the hand pose estimation system 100 includes a hand synergy heatmap solver 150 that receives the synergy heatmaps 140 from the synergy space encoders 130 and combines the multiple probability distributions into a unified representation for hand pose inference. The hand synergy heatmap solver 150 may operate by integrating the compatibility synergy heatmap 142, the observation synergy heatmap 144, the user synergy heatmap 146, and the synergy feasibility heatmap 148 into a single probabilistic framework that captures the combined constraints and observations from all encoding sources. The integration process performed by the hand synergy heatmap solver 150 may enable the system to leverage complementary information from different encoders while maintaining computational efficiency through probabilistic inference techniques. The hand synergy heatmap solver 150 may be configured to handle varying numbers of input heatmaps and may adapt the combination process based on the availability and quality of different information sources during real-time operation.

The hand synergy heatmap solver 150 may employ multiple approaches for combining the individual probability distributions from the synergy heatmaps 140 into a unified representation that supports robust inference. The combination process may involve weighting the individual distributions according to different use-cases and quality assessments of the respective encoders, enabling the hand synergy heatmap solver 150 to prioritize more reliable information sources while maintaining sensitivity to all available constraints. The weighting scheme may be adaptive and may adjust based on real-time assessments of encoder performance, environmental conditions, or task-specific requirements that influence the relative importance of different information sources. The hand synergy heatmap solver 150 may incorporate confidence measures from each encoder to dynamically adjust the contribution of different heatmaps during the combination process, thereby improving robustness when certain encoders provide uncertain or conflicting information.

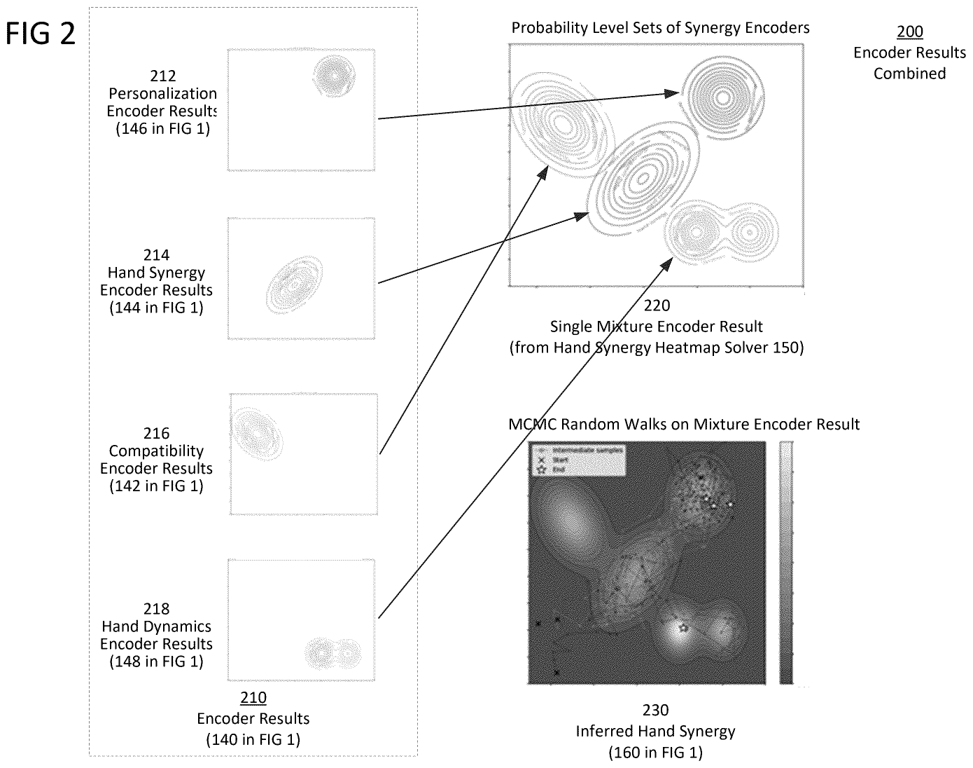

Referring to FIG. 2, the hand synergy heatmap solver 150 processes encoder results 200 that represent the combined output from multiple synergy encoder results 210 within the synergy space. The synergy encoder results 210 may comprise a personalization encoder result 212, a hand synergy encoder result 214, a compatibility encoder result 216, and a dynamics encoder result 218 that each contribute probabilistic information to the inference process. The personalization encoder result 212 may correspond to the user synergy heatmap 146 and may encode individual user characteristics and movement preferences within the synergy space representation. The hand synergy encoder result 214 may correspond to the observation synergy heatmap 144 and may represent direct observations of hand features and configurations derived from visual input processing. The compatibility encoder result 216 may correspond to the compatibility synergy heatmap 142 and may encode environmental and contextual constraints that influence feasible hand poses within the observed scene. The dynamics encoder result 218 may correspond to the synergy feasibility heatmap 148 and may enforce temporal consistency and realistic movement transitions within the synergy space.

The hand synergy heatmap solver 150 may combine the synergy encoder results 210 into a single mixture encoder result 220 that represents the integrated probability distribution across the synergy space. The single mixture encoder result 220 may be constructed by combining the individual probability distributions from each of the synergy encoder results 210 using probabilistic fusion techniques that preserve the statistical properties of the component distributions while enabling efficient inference. The single mixture encoder result 220 may represent a multi-modal probability distribution that captures the uncertainty and variability inherent in hand pose estimation under partial occlusion and incomplete information. The construction of the single mixture encoder result 220 may involve normalization procedures that ensure the combined distribution maintains proper probabilistic properties and may incorporate correlation modeling that accounts for dependencies between different information sources.

As further shown in FIG. 2, the hand synergy heatmap solver 150 may utilize Markov Chain Monte Carlo (MCMC) sampling techniques to perform inference on the single mixture encoder result 220 and determine the most likely hand configuration within the synergy space. The MCMC sampling approach may involve running multiple chains on each input map and combining the results to generate robust estimates of the posterior probability distribution over possible hand configurations. The MCMC implementation may employ multiple parallel chains that explore different regions of the synergy space, enabling comprehensive sampling of the probability landscape while avoiding local optima that might arise from single-chain approaches. The hand synergy heatmap solver 150 may utilize various MCMC algorithms, including Metropolis-Hastings sampling, Gibbs sampling, or Hamiltonian Monte Carlo methods, depending on the characteristics of the single mixture encoder result 220 and computational requirements of the specific application.

The MCMC sampling process performed by the hand synergy heatmap solver 150 may generate samples from the single mixture encoder result 220 that represent plausible hand configurations consistent with all available constraints and observations. The sampling chains may be initialized at different locations within the synergy space to ensure comprehensive exploration of the probability distribution and may incorporate adaptive step-size mechanisms that optimize sampling efficiency based on the local characteristics of the probability landscape. The hand synergy heatmap solver 150 may monitor convergence criteria across multiple chains to determine when sufficient samples have been collected to provide reliable estimates of the target distribution. The MCMC approach may enable the hand synergy heatmap solver 150 to handle complex, multi-modal distributions that arise when multiple plausible hand configurations are consistent with the available evidence, providing uncertainty quantification that reflects the confidence in the estimated hand pose.

The hand synergy heatmap solver 150 may alternatively employ Multiple Importance Sampling (MIS) techniques to perform inference of the combined synergy maps and generate estimates of the posterior distribution over hand configurations. The MIS approach may enable the hand synergy heatmap solver 150 to efficiently sample from the single mixture encoder result 220 by utilizing multiple proposal distributions that correspond to the individual synergy encoder results 210, thereby leveraging the structure of the component distributions to improve sampling efficiency. The MIS implementation may assign importance weights to samples drawn from different proposal distributions based on the relative contributions of the corresponding synergy encoder results 210, enabling the hand synergy heatmap solver 150 to focus computational resources on the most informative regions of the synergy space. The MIS technique may provide computational advantages over standard MCMC approaches when the single mixture encoder result 220 exhibits complex structure or when certain synergy encoder results 210 provide more reliable information than others.

With continued reference to FIG. 2, the inference process performed by the hand synergy heatmap solver 150 generates an inferred synergy 230 that represents the most likely hand configuration within the synergy space based on the combined evidence from all available information sources. The inferred synergy 230 may be represented as a point estimate within the synergy space, along with associated uncertainty measures that quantify the confidence in the estimated configuration. The hand synergy heatmap solver 150 may generate multiple candidate solutions when the single mixture encoder result 220 exhibits multi-modal characteristics, enabling downstream processing to consider alternative hand configurations that may be consistent with the available evidence. The inferred synergy 230 may include temporal consistency information that reflects the relationship between the current estimate and previous hand configurations, enabling smooth tracking of hand movements over time while maintaining responsiveness to rapid changes in hand pose.

The hand synergy heatmap solver 150 may incorporate feedback mechanisms that enable iterative refinement of the inferred synergy 230 based on additional information or updated encoder outputs. The feedback process may involve re-weighting the contributions of different synergy encoder results 210 based on the consistency between predicted and observed hand features, enabling the hand synergy heatmap solver 150 to adapt to changing conditions or improve performance based on accumulated evidence. The hand synergy heatmap solver 150 may maintain historical information about the reliability and performance of different encoders, enabling dynamic adjustment of the combination weights used in constructing the single mixture encoder result 220. The adaptive capabilities of the hand synergy heatmap solver 150 may enable the system to maintain robust performance across diverse operating conditions while continuously improving accuracy through experience with different hand poses, users, and environmental contexts.

With continued reference to FIG. 1, the hand pose estimation system 100 includes a hand synergy encoder 170 that receives an inferred hand synergy 160 from the hand synergy heatmap solver 150 and transforms the synergy space representation back into a full articulated hand model. The hand synergy encoder 170 may operate as a decoder component that performs the inverse transformation of the synergy space encoding process, converting the reduced-dimensional representation back into the complete twenty-two degree-of-freedom hand configuration. The transformation process performed by the hand synergy encoder 170 may utilize learned mappings that preserve the anatomical constraints and joint coupling relationships that were captured during the original dimensionality reduction process. The hand synergy encoder 170 may be implemented using neural networks, statistical models, or hybrid approaches that ensure the decoded hand configuration maintains anatomical feasibility while accurately reflecting the inferred synergy space coordinates.

The inferred hand synergy 160 may represent a point estimate within the synergy space that encodes the most likely hand configuration based on the combined evidence from all available information sources processed by the synergy space encoders 130. The inferred hand synergy 160 may comprise coordinate values within the reduced-dimensional space along with associated uncertainty measures that quantify the confidence in the estimated configuration. The hand synergy encoder 170 may process the inferred hand synergy 160 by applying inverse transformation functions that map the synergy space coordinates back to joint angle configurations, finger positions, and palm orientations within the full hand model. The decoding process may incorporate probabilistic elements that account for the uncertainty present in the inferred hand synergy 160, enabling the hand synergy encoder 170 to generate confidence intervals or probability distributions for the resulting joint configurations.

The hand synergy encoder 170 may utilize multiple approaches for performing the inverse transformation from synergy space to the full hand model, depending on the method used for the original dimensionality reduction and the computational requirements of the target application. When the synergy space was constructed using Principal Component Analysis techniques, the hand synergy encoder 170 may apply the transpose of the projection matrix used during encoding, scaled by the appropriate eigenvalues to reconstruct the full-dimensional hand configuration. The PCA-based decoding approach may provide computational efficiency through matrix operations that can be optimized for various hardware platforms, including CPU-based systems and vision processing units. The hand synergy encoder 170 may incorporate bias correction terms that account for the mean hand configuration used during the PCA analysis, ensuring that the decoded hand pose accurately reflects the intended configuration within the original coordinate system.

When the synergy space encoding was performed using neural network approaches, the hand synergy encoder 170 may employ corresponding neural network architectures that learn the inverse mapping from synergy coordinates to joint configurations. The neural network implementation of the hand synergy encoder 170 may capture nonlinear relationships between synergy space coordinates and joint angles, enabling more accurate reconstruction of complex hand poses that exhibit coupling between multiple degrees of freedom. The hand synergy encoder 170 may be trained using paired datasets that contain both synergy space representations and corresponding full hand configurations, enabling supervised learning of the inverse transformation. The neural network approach may provide flexibility in handling variations in hand size, joint range limitations, and individual anatomical differences that may influence the relationship between synergy coordinates and physical joint configurations.

As further shown in FIG. 1, the hand synergy encoder 170 generates a hand pose 180 that represents the output of the hand pose estimation system 100 in the form of a complete twenty-two degree-of-freedom hand configuration. The hand pose 180 may comprise joint angle values, finger positions, palm orientation, and associated confidence measures that quantify the reliability of each estimated parameter. The hand synergy encoder 170 may format the hand pose 180 according to standard hand model representations used in extended reality applications, robotics systems, or computer graphics frameworks, enabling direct integration with downstream processing components. The hand pose 180 may include temporal consistency information that relates the current estimate to previous hand configurations, enabling smooth tracking of hand movements while maintaining responsiveness to rapid changes in hand position or configuration.

The hand synergy encoder 170 may incorporate post-processing operations that refine the hand pose 180 to ensure anatomical feasibility and consistency with the physical constraints of human hand articulation. The hand synergy encoder 170 may apply collision detection algorithms that prevent finger interpenetration or unrealistic spatial relationships between different parts of the hand model. The refinement process may utilize iterative optimization techniques that adjust joint configurations to minimize violations of physical constraints while preserving the overall hand configuration indicated by the inferred hand synergy 160. The post-processing operations performed by the hand synergy encoder 170 may be computationally lightweight to maintain real-time performance.

The hand pose estimation system 100 may further include a wrist pose estimator 190 that determines a six-degree-of-freedom (6 DoF) pose of the wrist relative to a camera frame. The wrist pose estimator 190 may receive the hand pose 180 and establish the spatial relationship between the decoded hand configuration and the camera coordinate system. A three-dimensional hand model may be generated and projected onto the camera image for comparison with observed hand features, enabling applications such as augmented reality overlays, robotic grasping, and object manipulation.

The wrist pose estimator 190 may employ either a canonical hand model, representing standardized proportions and joint relationships, or a learned model specific to an identified user. The selected model may be projected onto the camera image plane to generate predicted keypoint locations corresponding to fingertips, joint centers, and knuckle positions. Perspective-n-Point (PnP) algorithms may then establish the spatial transformation between the model and the camera coordinate system, enabling 6 DoF pose determination even under partial occlusion or detection errors.

To improve robustness, the wrist pose estimator 190 may perform keypoint matching between projected model keypoints and those detected directly from the camera image by the hand keypoints detector 114. Geometric consistency constraints and Random Sample Consensus (RANSAC) techniques may be applied to reject outliers and refine the PnP solution.

The 6 DoF wrist pose output may comprise three translational degrees of freedom specifying wrist position and three rotational degrees of freedom defining wrist orientation relative to the camera. Confidence measures may accompany the output to reflect the quality of keypoint matching and geometric consistency. This wrist pose information may support downstream applications including accurate virtual object placement, collision detection, and robotic hand-eye coordination.

The hand pose estimation system 100 may be configured to capture compute cycles by enabling the implementation of shallower models that are more suitable for deployment on CPU-based systems and vision processing units compared to traditional GPU-intensive approaches. The reduced dimensionality of the synergy space representation may enable the hand synergy encoder 170 to utilize simpler neural network architectures or more efficient statistical models that require fewer computational resources during inference. The computational efficiency gains achieved through synergy space processing may enable deployment of the hand pose estimation system 100 on smart-camera devices and embedded systems that have limited processing capabilities compared to high-performance computing platforms. The hand synergy encoder 170 may be optimized for specific hardware architectures, including CPU vector processing units and specialized vision processing chips, enabling real-time hand pose estimation in resource-constrained environments while maintaining accuracy comparable to more computationally intensive approaches.

With continued reference to FIG. 1, the hand pose estimation system 100 generates heatmaps for downstream tasks 190 that provide additional probabilistic information derived from the synergy space processing pipeline for use by external applications or processing components. The heatmaps for downstream tasks 190 may comprise probability distributions, confidence maps, or uncertainty quantification data that can be utilized by robotics control systems, gesture recognition algorithms, or extended reality applications that require detailed information about hand pose estimation reliability.

The hand pose estimation system 100 operates through a coordinated sequence of processing stages that transform visual input data into accurate hand pose estimates while maintaining robustness under challenging occlusion conditions. The operational flow begins with parallel processing of input data through multiple detection and encoding pathways, followed by probabilistic fusion in the synergy space, and concludes with decoding to generate the final hand pose output. The system architecture enables real-time processing by distributing computational workloads across multiple specialized components that operate concurrently while sharing information through well-defined interfaces. The integration of multiple information sources throughout the processing pipeline provides redundancy and error correction capabilities that enhance system performance when individual components encounter challenging input conditions or partial failures.

Referring to FIG. 1, the operational flow commences when input data 10 enters the hand pose estimation system 100 and undergoes simultaneous processing by the input/detection components 110. The parallel processing architecture enables the system to extract multiple types of information from the same input data without introducing sequential bottlenecks that might compromise real-time performance requirements. The environment encoder 112, hand keypoints detector 114, object detector 116, and user identifier 118 operate concurrently to generate complementary representations of the visual scene, hand features, object characteristics, and user identity information. The parallel extraction process ensures that computational resources are utilized efficiently while maintaining comprehensive analysis of all relevant aspects of the input data that may influence hand pose estimation accuracy.

The outputs generated by the input/detection components flow simultaneously into the synergy space encoders 130, where each encoder transforms its respective input into a probability distribution within the reduced-dimensional synergy space. The compatibility map encoder 132 processes environmental constraints to generate spatial and contextual probability maps that reflect feasible hand configurations within the observed scene. The hand synergy encoder 134 transforms detected hand features into synergy space representations that capture the observed hand configuration while accounting for measurement uncertainty and potential occlusions. The personalization encoder 136 incorporates user-specific information to generate probability distributions that reflect individual movement patterns and grasping preferences. The hand synergy dynamics encoder 138 processes temporal information to generate probability distributions that enforce realistic movement transitions and maintain temporal consistency across sequential hand pose estimates.

The synergy space encoding process enables the system to handle partial occlusions and incomplete visual information by transforming the estimation problem into a probabilistic framework that can accommodate uncertainty and missing data. When hand features are partially occluded by objects or environmental elements, the hand synergy encoder 134 may generate broader probability distributions that reflect the increased uncertainty in the observed configuration. The compatibility map encoder 132 may compensate for missing hand information by providing stronger constraints based on environmental context and object interaction patterns. The personalization encoder 136 may contribute user-specific priors that help disambiguate between multiple plausible hand configurations when visual evidence is insufficient. The hand synergy dynamics encoder 138 may provide temporal constraints that limit the range of feasible hand poses based on the previous hand configuration and learned movement patterns.

With continued reference to FIG. 1, the synergy heatmaps 140 generated by the individual encoders 130 are processed by the hand synergy heatmap solver 150, which performs probabilistic fusion to combine the multiple information sources into a unified representation. The fusion process accounts for the reliability and confidence levels of each encoder output, enabling the system to weight different information sources appropriately based on current operating conditions and historical performance data. The hand synergy heatmap solver 150 may dynamically adjust the relative contributions of different encoders 130 based on real-time assessments of data quality, environmental conditions, and task requirements. The probabilistic fusion approach enables the system 100 to maintain robust performance even when individual encoders provide conflicting or uncertain information, by leveraging the consensus among multiple information sources to generate reliable estimates.

Referring to FIG. 2, the probabilistic fusion process combines the individual synergy models into a single mixture model that represents the integrated probability distribution across the synergy space. The fusion process preserves the statistical properties of the component distributions while enabling efficient inference through sampling or optimization techniques. The single mixture model may exhibit multi-modal characteristics when multiple plausible hand configurations are consistent with the available evidence, enabling the system to represent uncertainty and alternative interpretations of the input data. The hand synergy heatmap solver 150 processes the single mixture model using sampling techniques that explore the probability landscape to identify the most likely hand configuration while quantifying the uncertainty associated with the estimate.

The inference process performed by the hand synergy heatmap solver 150 generates a point estimate within the synergy space that represents the most probable hand configuration based on the combined evidence from all available information sources. The inference process may utilize multiple parallel sampling chains or importance sampling techniques to ensure comprehensive exploration of the probability distribution and avoid local optima that might arise from single-point optimization approaches. The sampling process generates not only a point estimate but also uncertainty measures that quantify the confidence in the estimated configuration and identify regions of the synergy space where alternative hand configurations remain plausible. The probabilistic inference approach enables the system to provide uncertainty quantification that can be utilized by downstream applications to make informed decisions about how to utilize the hand pose estimates.

The inferred hand synergy generated by the hand synergy heatmap solver 150 undergoes transformation back to the full hand model through the hand synergy encoder 134, which performs the inverse mapping from the reduced-dimensional synergy space to the complete twenty-two degree-of-freedom hand configuration. The decoding process applies learned or computed inverse transformations that preserve the anatomical constraints and joint coupling relationships captured during the original dimensionality reduction process. The hand synergy encoder 134 may incorporate post-processing operations that ensure the decoded hand pose satisfies physical constraints while accurately reflecting the inferred synergy space coordinates. The decoding process generates the final hand pose output along with confidence measures that reflect the uncertainty propagated through the entire processing pipeline.

As further shown in FIG. 1, the complete operational flow from input processing to final pose output enables the system to maintain robust performance under occlusion conditions through multiple complementary mechanisms. The parallel processing architecture ensures that multiple information sources remain available even when individual components encounter challenging input conditions. The probabilistic framework enables graceful degradation of performance when visual information is incomplete, by utilizing uncertainty quantification to reflect the reduced confidence in estimates generated from partial data. The synergy space representation constrains inference results to anatomically feasible configurations, preventing the generation of impossible hand poses even when visual evidence is ambiguous or conflicting. The temporal consistency enforcement provided by the hand synergy dynamics encoder 138 ensures smooth tracking of hand movements while maintaining responsiveness to rapid changes in hand configuration.

The integrated system architecture enables continuous adaptation and improvement through feedback mechanisms that monitor performance and adjust processing parameters based on accumulated experience. The personalization encoder 136 continuously learns from user interactions to refine individual movement models and improve estimation accuracy for specific users over time. The hand synergy dynamics encoder 138 adapts temporal models based on observed movement patterns, enabling the system to capture task-specific dynamics and individual movement characteristics. The hand synergy heatmap solver 150 may adjust fusion weights based on the historical performance of different encoders under various operating conditions, enabling the system to optimize the combination of information sources for different scenarios. The adaptive capabilities of the integrated system enable sustained performance improvement while maintaining robustness across diverse operating environments and user populations.

Although the foregoing description has focused on the estimation of human hand poses, the principles of the present disclosure are not limited to the human hand. The concepts of synergy-based dimensionality reduction, context-aware inference, and probabilistic decoding are broadly applicable to any articulated structure comprising multiple joints. Examples include other parts of the human body (such as arms, legs, or fingers considered individually), robotic manipulators, prosthetic devices, or even non-human articulated systems exhibiting constrained joint motion. In each of these cases, the high-dimensional joint configuration space can be reduced to a lower-dimensional synergy space that captures the most relevant coupled motions, enabling more robust pose estimation, especially under occlusion or incomplete observations. Accordingly, references herein to “hand,” “hand pose,” or “hand synergies” are intended as exemplary aspects, and should not be construed as limiting the scope of the disclosure.

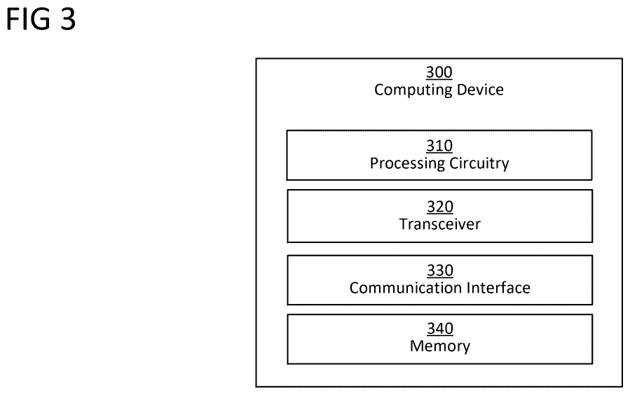

FIG. 3 illustrates a computing device 300, in accordance with aspects of the disclosure.

The computing device 300 may be identified with a central controller and be implemented as any suitable network infrastructure component, which may be implemented as a cloud/edge network server, controller, computing device, etc. The computing device 300 may serve the hand pose estimation system 100, the synergy space encoders 130, the hand synergy heatmap solver 150, and the synergy decoder 170, in accordance with the various techniques discussed herein. To do so, the computing device 300 may include processing circuitry 310, a transceiver 320, a communication interface 330, and a memory 340. The components shown in FIG. 3 are provided for ease of explanation, and the computing device 300 may implement additional, fewer, or alternative components than those shown in FIG. 3.

The processing circuitry 310 may be operable as any suitable number and/or type of computer processor that may function to control the computing device 300. The processing circuitry 310 may be identified with one or more processors (or suitable portions thereof) implemented by the computing device 300. The processing circuitry 310 may be identified with one or more processors such as a host processor, a digital signal processor, one or more microprocessors, graphics processors, baseband processors, microcontrollers, an application-specific integrated circuit (ASIC), a portion (or the entirety of) a field-programmable gate array (FPGA), vision processing units (VPUs), or specialized neural processing units optimized for machine learning inference operations.

In any case, the processing circuitry 310 may be operable to execute instructions to perform arithmetic, logic, and/or input/output (I/O) operations and/or to control the operation of one or more components of the computing device 300 to perform various functions as described herein. The processing circuitry 310 may include one or more microprocessor cores, memory registers, buffers, clocks, etc. The processing circuitry 310 may generate electronic control signals associated with the components of the computing device 300 to control and/or modify the operation of those components. The processing circuitry 310 may communicate with and/or control functions associated with the transceiver 320, the communication interface 330, and/or the memory 340. The processing circuitry 310 may additionally perform various operations to execute the hand pose estimation algorithms, manage synergy space transformations, coordinate probabilistic inference operations, and control the communications with camera systems, extended reality devices, or robotic platforms that utilize hand pose information.

The transceiver 320 may be implemented as any suitable number and/or type of components operable to transmit and/or receive data packets and/or wireless signals in accordance with any suitable number and/or type of communication protocols. The transceiver 320 may facilitate communication with camera systems, depth sensors, extended reality headsets, robotic control systems, or other devices that provide input data or consume hand pose estimation results. The transceiver 320 may include any suitable type of components to facilitate this functionality, including components associated with known transceiver, transmitter, and/or receiver operations, configurations, and implementations. Although shown as a transceiver in FIG. 3, the transceiver 320 may include any suitable number of transmitters, receivers, or combinations thereof, which may be integrated into a single transceiver or as multiple transceivers or transceiver modules. The transceiver 320 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 330 may be implemented as any suitable number and/or type of components operable to facilitate the transceiver 320 to receive and/or transmit data and/or signals in accordance with one or more communication protocols, as discussed herein. The communication interface 330 may be implemented as any suitable number and/or type of components operable to interface with the transceiver 320, such as analog-to-digital converters (ADCs), digital-to-analog converters, intermediate frequency (IF) amplifiers and/or filters, modulators, demodulators, baseband processors, and the like. The communication interface 330 may thus operate in conjunction with the transceiver 320 and form part of an overall communication circuitry implemented by the computing device 300, which may be implemented via the computing device 300 to transmit commands and/or control signals to perform any of the hand pose estimation functions described herein. The communication interface 330 may support various communication protocols including USB, Ethernet, Wi-Fi, Bluetooth, or specialized protocols for camera data streaming and real-time hand pose data transmission.

The memory 340 is operable to store data and/or instructions such that when the instructions are executed by the processing circuitry 310, they cause the computing device 300 to perform various functions as described herein. The memory 340 may be implemented as any known volatile and/or non-volatile memory, including, for example, read-only memory (ROM), random access memory (RAM), flash memory, a magnetic storage medium, an optical disk, erasable programmable read-only memory (EPROM), programmable read-only memory (PROM), etc. The memory 340 may be non-removable, removable, or a combination of the two. The memory 340 may be implemented as a non-transitory computer-readable medium storing one or more executable instructions such as logic, algorithms, code, etc. The memory 340 may store synergy space transformation matrices, learned user personalization models, environmental compatibility maps, hand dynamics models, and other data structures required for the hand pose estimation operations described herein.

As further discussed below, the instructions, logic, code, etc., stored in the memory 340 are represented by the various modules/engines as shown in FIG. 3. Alternatively, when implemented via hardware, the modules/engines shown in FIG. 3 associated with the memory 340 may include instructions and/or code to facilitate control and/or monitoring of the operation of such hardware components. In other words, the modules/engines shown in FIG. 3 are provided to facilitate an explanation of the functional association between hardware and software components. Thus, the processing circuitry 310 may execute the instructions stored in these respective modules/engines in conjunction with one or more hardware components to perform the various hand pose estimation functions discussed herein.

Various aspects described herein may utilize one or more machine learning models for the input/detection components 110, the synergy space encoders 130, the hand synergy heatmap solver 150, and the synergy decoder 170. The term “model,” as used herein, may be understood to mean any type of algorithm that provides output data from input data (e.g., any type of algorithm that generates or calculates output data from input data). A machine learning model can be executed by a computing system to progressively improve the performance of a particular task. In some aspects, the parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be tuned during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, each of the machine learning models may utilize supervised learning, semi-supervised learning, unsupervised learning, or reinforcement learning techniques. The machine learning models may be specifically adapted for hand pose estimation tasks, including convolutional neural networks for hand keypoint detection, recurrent neural networks for temporal hand dynamics modeling, and probabilistic models for synergy space inference operations.

In supervised learning, the model may be built using a training set of data that includes both the inputs and the corresponding desired outputs (illustratively, each input may be associated with a desired or expected output for that input). Each training instance may include one or more inputs and a desired output. For hand pose estimation applications, training data may comprise RGB images or depth sensor data paired with ground truth hand joint configurations, synergy space coordinates, or hand keypoint locations. Training may involve iterating through training instances and using an objective function to teach the model to predict the output for new inputs (illustratively, for inputs not included in the training set). In semi-supervised learning, a portion of the inputs in the training set may lack corresponding desired outputs (e.g., one or more inputs may not be associated with any desired or expected output).

In unsupervised learning, the model may be built from a training set of data that includes only inputs and no desired outputs. The unsupervised model may be used to find structure in the data (e.g., grouping or clustering of data points), for example, by discovering patterns in the data. For hand pose estimation, unsupervised learning may be utilized to discover natural hand synergy patterns, identify common grasping configurations, or learn environmental compatibility relationships without explicit labeling. Techniques that may be implemented in an unsupervised learning model may, for example, self-organizing maps, nearest-neighbor mapping, k-means clustering, and singular value decomposition.

Reinforcement learning models may include positive or negative feedback to improve accuracy. A reinforcement learning model may attempt to maximize one or more goals/rewards. For hand pose estimation applications, reinforcement learning may be utilized to optimize personalization models based on user interaction feedback or to improve temporal consistency in hand tracking applications. Techniques that may be implemented in a reinforcement learning model may include, for example, Q-learning, temporal difference (TD), and deep adversarial networks.

Various aspects described herein may utilize one or more classification models. In a classification model, outputs may be restricted to a limited set of values (e.g., one or more classes). The classification model may output a class for an input set of one or more input values. An input set may include sensor data, such as image data, depth sensor data, infrared data, and the like. A classification model as described herein may, for example, classify hand poses into discrete categories, identify manipulation modes, classify environmental objects, or determine user identities for personalization purposes. References herein to classification models may contemplate a model that implements, for example, one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (e.g., starting from or using an input set of one or more values). For hand pose estimation, regression models may be utilized to predict continuous joint angles, synergy space coordinates, or confidence values associated with pose estimates. References herein to regression models may contemplate a model that implements, for example, one or more of the following techniques (or other suitable techniques): linear regression, decision trees, random forests, or neural networks.

A machine learning model described herein may be or include a neural network. The neural network may be any type of neural network, such as a convolutional neural network, an autoencoder network, a variational autoencoder network, a sparse autoencoder network, a recurrent neural network, a deconvolutional network, a generative adversarial network, a forward-thinking neural network, a sum-product neural network, and the like. For hand pose estimation applications, convolutional neural networks may be particularly suitable for processing visual input data, while recurrent neural networks may be utilized for modeling temporal hand dynamics and movement patterns. The neural network can have any number of layers. The training of the neural network (e.g., the adaption of the layers of the neural network) may use or be based on any kind of training principle, such as backpropagation (e.g., using the backpropagation algorithm).

A number of implementations have been described. Nevertheless, it will be understood that various modifications may be made without departing from the spirit and scope of the disclosure. Accordingly, other implementations are within the scope of the following claims.

The techniques described in this disclosure may also be illustrated in the following examples.

Example 1. An articulated structure pose estimation system, comprising: a plurality of synergy space encoders, each configured to generate a respective probability distribution in a synergy space having fewer dimensions than a full joint space, the full joint space corresponding to a multi-degree-of-freedom model of an articulated structure, wherein different ones of the synergy space encoders are configured to encode different contextual or observational information related to articulated structure pose estimation; a synergy heatmap solver configured to: combine the respective probability distributions from the plurality of synergy space encoders to generate a combined probability distribution in the synergy space; and perform probabilistic inference on the combined probability distribution to determine an inferred synergy point; and a synergy decoder configured to decode the inferred synergy point into a pose representation of the articulated structure in the full joint space.

Example 2. The articulated structure pose estimation system of example 1, wherein the plurality of synergy space encoders comprises: a compatibility map encoder configured to generate a compatibility probability distribution based on environmental context and object interactions; a synergy encoder configured to generate an observation probability distribution based on detected articulated structure landmarks; and a personalization encoder configured to generate a personalized probability distribution based on user-specific interaction patterns.

Example 3. The articulated structure pose estimation system of example 2, wherein the plurality of synergy space encoders further comprises: a synergy dynamics encoder configured to generate a feasibility probability distribution based on previously detected articulated structure synergies and learned synergy mode transitions.

Example 4. The articulated structure pose estimation system of any one or more of examples 1-3, wherein the synergy dynamics encoder is configured to: identify manipulation modes by clustering manipulation actions in the synergy space using density-based spatial clustering algorithms; and learn transition probabilities between the manipulation modes based on observed articulated structure movement sequences.

Example 5. The articulated structure pose estimation system of any one or more of examples 1-4, wherein the synergy dynamics encoder is configured to utilize dynamical system identification techniques to determine governing equations that describe articulated structure movement dynamics from observed trajectory data.

Example 6. The articulated structure pose estimation system of any one or more of examples 1-5, wherein the compatibility map encoder is configured to process environmental image data with articulated structure information removed or masked to focus on environmental constraints for compatibility map generation.

Example 7. The articulated structure pose estimation system of any one or more of examples 1-6, wherein the compatibility map encoder is configured to: process initial images captured before a presence of the articulated structure in a scene; and generate task-conditioned compatibility maps by integrating task graph representations, scene object representations, and user personalization data.

Example 8. The articulated structure pose estimation system of any one or more of examples 1-7, wherein the compatibility map encoder is configured to perform object segmentation to isolate environmental context from articulated structure presence during compatibility map generation.

Example 9. The articulated structure pose estimation system of any one or more of examples 1-8, wherein the synergy encoder comprises a machine learning model trained to map detected articulated structure landmarks into the synergy space, the model being configured to capture dependencies between articulated structure joints.

Example 10. The articulated structure pose estimation system of any one or more of examples 1-9, wherein the personalization encoder is configured to: receive user identification information, object classification data, and inferred synergy data; and adapt the personalized probability distribution based on user-specific grasping preferences, manipulation styles, and object interaction patterns.

Example 11. The articulated structure pose estimation system of any one or more of examples 1-10, wherein the synergy heatmap solver is configured to: apply weighted combinations to the respective probability distributions based on quality assessments of the synergy space encoders; and dynamically adjust weighting factors according to real-time performance evaluations and use-case requirements.

Example 12. The articulated structure pose estimation system of any one or more of examples 1-11, wherein the synergy heatmap solver is configured to: combine the probability distributions using Markov Chain Monte Carlo sampling techniques with multiple parallel chains; and generate the inferred synergy point with associated confidence intervals.

Example 13. The articulated structure pose estimation system of any one or more of examples 1-12, wherein the synergy heatmap solver is configured to utilize importance sampling techniques to perform the probabilistic inference on the combined probability distribution.

Example 14. The articulated structure pose estimation system of any one or more of examples 1-13, wherein the articulated structure is a human hand, and the synergy space represents hand configurations using approximately nine dimensions that capture synergistic finger motions, the nine dimensions being derived from principal component analysis of human hand movement data.

Example 15. The articulated structure pose estimation system of any one or more of examples 1-14, wherein the articulated structure is a human hand, and the synergy space represents articulated structure configurations using fewer than nine dimensions for applications where computational efficiency takes precedence over pose fidelity.

Example 16. The articulated structure pose estimation system of any one or more of examples 1-15, wherein the synergy dynamics encoder is further configured to: construct transition probability matrices encoding likelihood of movement between synergy modes; and enforce temporal consistency by constraining articulated structure pose transitions to anatomically feasible movement patterns.

Example 17. The articulated structure pose estimation system of any one or more of examples 1-16, wherein the synergy decoder is configured to apply inverse transformation functions and incorporate constraint enforcement to ensure anatomically feasible articulated structure pose outputs.

Example 18. The articulated structure pose estimation system of any one or more of examples 1-17, further comprising input detection components configured to generate environmental context data, articulated structure landmark data, object classification data, and user identification data for processing by the plurality of synergy space encoders.

Example 19. At least one non-transitory computer-readable medium comprising instructions stored thereon, that if executed by one or more processors, cause the one or more processors to: generate, using a plurality of synergy space encoders, respective probability distributions in a synergy space having fewer dimensions than a full joint space, the full joint space corresponding to a multi-degree-of-freedom model of an articulated structure, wherein different ones of the synergy space encoders encode different contextual or observational information related to articulated structure pose estimation; combine the respective probability distributions from the plurality of synergy space encoders to generate a combined probability distribution in the synergy space; perform probabilistic inference on the combined probability distribution to determine an inferred synergy point; and decode the inferred synergy point into a pose representation of the articulated structure in the full joint space.

Example 20. The at least one non-transitory computer-readable medium of example 19, wherein the instructions further cause the one or more processors to: generate a compatibility probability distribution based on environmental context and object interactions; generate an observation probability distribution based on detected articulated structure landmarks; and generate a personalized probability distribution based on user-specific interaction patterns.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. An articulated structure pose estimation system, comprising:
a plurality of synergy space encoders, each configured to generate a respective probability distribution in a synergy space having fewer dimensions than a full joint space, the full joint space corresponding to a multi-degree-of-freedom model of an articulated structure, wherein different ones of the synergy space encoders are configured to encode different contextual or observational information related to articulated structure pose estimation;
a synergy heatmap solver configured to:
combine the respective probability distributions from the plurality of synergy space encoders to generate a combined probability distribution in the synergy space; and
perform probabilistic inference on the combined probability distribution to determine an inferred synergy point; and
a synergy decoder configured to decode the inferred synergy point into a pose representation of the articulated structure in the full joint space.

2. The articulated structure pose estimation system of claim 1, wherein the plurality of synergy space encoders comprises:
a compatibility map encoder configured to generate a compatibility probability distribution based on environmental context and object interactions;
a synergy encoder configured to generate an observation probability distribution based on detected articulated structure landmarks; and
a personalization encoder configured to generate a personalized probability distribution based on user-specific interaction patterns.

3. The articulated structure pose estimation system of claim 2, wherein the plurality of synergy space encoders further comprises:
a synergy dynamics encoder configured to generate a feasibility probability distribution based on previously detected articulated structure synergies and learned synergy mode transitions.

4. The articulated structure pose estimation system of claim 3, wherein the synergy dynamics encoder is configured to:
identify manipulation modes by clustering manipulation actions in the synergy space using density-based spatial clustering algorithms; and
learn transition probabilities between the manipulation modes based on observed articulated structure movement sequences.

5. The articulated structure pose estimation system of claim 3, wherein the synergy dynamics encoder is configured to utilize dynamical system identification techniques to determine governing equations that describe articulated structure movement dynamics from observed trajectory data.

6. The articulated structure pose estimation system of claim 2, wherein the compatibility map encoder is configured to process environmental image data with articulated structure information removed or masked to focus on environmental constraints for compatibility map generation.

7. The articulated structure pose estimation system of claim 2, wherein the compatibility map encoder is configured to:
process initial images captured before a presence of the articulated structure in a scene; and
generate task-conditioned compatibility maps by integrating task graph representations, scene object representations, and user personalization data.

8. The articulated structure pose estimation system of claim 2, wherein the compatibility map encoder is configured to perform object segmentation to isolate environmental context from articulated structure presence during compatibility map generation.

9. The articulated structure pose estimation system of claim 2, wherein the synergy encoder comprises a machine learning model trained to map detected articulated structure landmarks into the synergy space, the model being configured to capture dependencies between articulated structure joints.

10. The articulated structure pose estimation system of claim 2, wherein the personalization encoder is configured to:
receive user identification information, object classification data, and inferred synergy data; and
adapt the personalized probability distribution based on user-specific grasping preferences, manipulation styles, and object interaction patterns.

11. The articulated structure pose estimation system of claim 1, wherein the synergy heatmap solver is configured to:
apply weighted combinations to the respective probability distributions based on quality assessments of the synergy space encoders; and
dynamically adjust weighting factors according to real-time performance evaluations and use-case requirements.

12. The articulated structure pose estimation system of claim 1, wherein the synergy heatmap solver is configured to:
combine the probability distributions using Markov Chain Monte Carlo sampling techniques with multiple parallel chains; and
generate the inferred synergy point with associated confidence intervals.

13. The articulated structure pose estimation system of claim 1, wherein the synergy heatmap solver is configured to utilize importance sampling techniques to perform the probabilistic inference on the combined probability distribution.

14. The articulated structure pose estimation system of claim 1, wherein the articulated structure is a human hand, and the synergy space represents hand configurations using approximately nine dimensions that capture synergistic finger motions, the nine dimensions being derived from principal component analysis of human hand movement data.

15. The articulated structure pose estimation system of claim 1, wherein the articulated structure is a human hand, and the synergy space represents articulated structure configurations using fewer than nine dimensions for applications where computational efficiency takes precedence over pose fidelity.

16. The articulated structure pose estimation system of claim 3, wherein the synergy dynamics encoder is further configured to:
construct transition probability matrices encoding likelihood of movement between synergy modes; and
enforce temporal consistency by constraining articulated structure pose transitions to anatomically feasible movement patterns.

17. The articulated structure pose estimation system of claim 1, wherein the synergy decoder is configured to apply inverse transformation functions and incorporate constraint enforcement to ensure anatomically feasible articulated structure pose outputs.

18. The articulated structure pose estimation system of claim 1, further comprising input detection components configured to generate environmental context data, articulated structure landmark data, object classification data, and user identification data for processing by the plurality of synergy space encoders.

19. At least one non-transitory computer-readable medium comprising instructions stored thereon, that if executed by one or more processors, cause the one or more processors to:
generate, using a plurality of synergy space encoders, respective probability distributions in a synergy space having fewer dimensions than a full joint space, the full joint space corresponding to a multi-degree-of-freedom model of an articulated structure, wherein different ones of the synergy space encoders encode different contextual or observational information related to articulated structure pose estimation;
combine the respective probability distributions from the plurality of synergy space encoders to generate a combined probability distribution in the synergy space;
perform probabilistic inference on the combined probability distribution to determine an inferred synergy point; and
decode the inferred synergy point into a pose representation of the articulated structure in the full joint space.

20. The at least one non-transitory computer-readable medium of claim 19, wherein the instructions further cause the one or more processors to:
generate a compatibility probability distribution based on environmental context and object interactions;
generate an observation probability distribution based on detected articulated structure landmarks; and
generate a personalized probability distribution based on user-specific interaction patterns.
